(19) United States
(12) Patent Application Publication
(10) Pub. No.: US 2004/0189543 A1
(43) Pub. Date: Sep. 30, 2004

(54) Apparatus, methods and articles of manufacture for flexible antennas

(75) Inventors: David Frederick Jordan, Danville, NH (US); Albert David Kozlovski, Atkinson, NH (US)

Correspondence Address: TYCO ELECTRONICS CORPORATION, 4550 NEW LINDEN HILL ROAD, SUITE 450, WILMINGTON, DE, 19808, US

(73) Assignee: M/A COM, Inc., LOWELL, MA

(21) Appl. No.: 10/607,395

(22) Filed: Jun. 26, 2003

Related U.S. Application Data
(60) Provisional application No. 60/458,997, filed on Mar. 31, 2003.

(51) Int. Cl. H01Q 9/30

(52) U.S. Cl. 343/900; 343/702

(57) ABSTRACT

The invention is directed to a flexible antenna comprising a plurality of strands of a nickel-titanium alloy, mountable on a base assembly of an antenna system, for transmitting signals from and receiving signals to said antenna. In one embodiment, the strands of nickel-titanium alloy may be configured as one or more selected from the group consisting of 7×1 and 9×3. A mast stud in the base assembly may be used for receiving a signal cable for communication with the antenna element. The assembly may also include a printed circuit board. A sleeve may be mounted over at least a portion of the antenna element and a radome mounted over at least a portion of the antenna element and the base assembly.

### CROSS-REFERENCE TO RELATED APPLICATIONS

The present application claims the priority of U.S. Provisional Patent Application Serial No. 60/458,997, filed on Mar. 31, 2003, which is herein incorporated in its entirety by reference.

### FIELD OF THE INVENTION

The field of the invention is antenna systems, and more particularly antennas incorporating a nickel titanium whip element.

### BACKGROUND

Small mobile antennas based upon flexible whip technology generally utilize stranded stainless steel wire, and non-stranded nickel titanium wire. While nickel titanium wire is more commonly used than stainless steel, it is very flexible and does not typically set well under normal use. The high tensile strength of these conventional antennas may cause failure under a sudden shock, such as when the antenna is dropped from a height of three feet or more onto a hard surface (e.g., a concrete floor). The conventional whip antenna (Stranded or non-stranded steel or non-stranded nickel titanium wire), for example, may bend, take a set, break, or develop a latent defect, causing a break after flexing. In the event of a typical car wash test, to meet automotive standards, the whip element of a mobile antenna is subjected to striking 1600 times at the top of the element to simulate ten years of exposure. Conventional whip antennas, including non-stranded nickel titanium antennas, fail this test in varying degrees.

Accordingly, it would be beneficial to have a stranded wire nickel titanium whip antenna that can repeatedly absorb impact shocks and a car wash test cycle with minimal or no damage.

### SUMMARY OF THE INVENTION

Embodiments of the invention include an antenna incorporating a stranded nickel titanium element for transmitting signals from and receiving signals to the antenna and a base assembly for mounting the stranded nickel titanium element to a surface.

A flexible, whip antenna element may be used that comprises a plurality of strands of a nickel-titanium alloy, mountable on a base assembly of an antenna system, for transmitting signals from and receiving signals to said antenna. In one embodiment, the strands of nickel-titanium alloy may be configured as one or more selected from the group consisting of 7×1 and 9×3. A mast stud in the base assembly may be used for receiving a signal cable for communication with the antenna element. The assembly may also include a printed circuit board. A sleeve may be mounted over at least a portion of the antenna element and a radome mounted over at least a portion of the antenna element and the base assembly.

### BRIEF DESCRIPTION OF THE DRAWINGS

FIG. 1(a) is an exploded side elevation of an embodiment of an antenna incorporating the invention.

FIG. 1(b) is a cut-away elevation of an embodiment of an assembled antenna incorporating the invention.

### DETAILED DESCRIPTION

The invention will be understood more fully from the description given below and from the accompanying drawings of embodiments of the invention; which, however, do not limit the invention to any specific embodiment but are for explanation and understanding only.

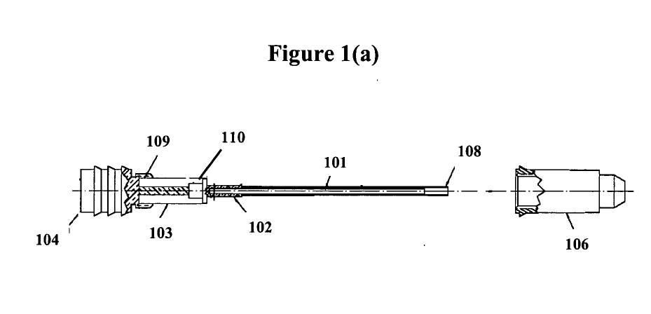

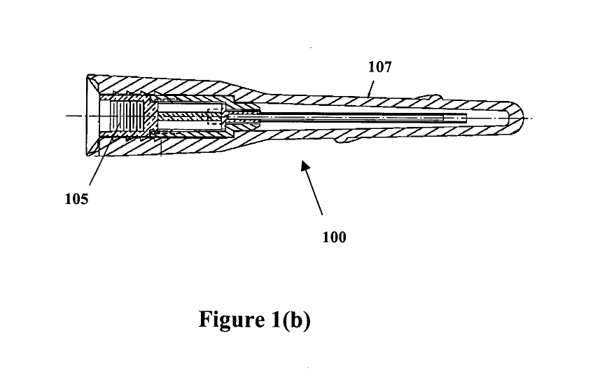

One embodiment of the invention is shown in FIGS. 1(a) and 1(b). Of course, those of ordinary skill in the art will appreciate that the system of the invention may be used in any possible configuration: PCB or no PCB, coil or otherwise, AMPS or PCS, dual band or single band, etc. In the illustrated embodiment, an antenna assembly 100 may include a flexible element for transmitting and/or receiving a communication signal, such as element 101.

In one embodiment, element 101 may be a whip antenna element incorporating stranded nickel titanium (NiTi) wire. The nickel titanium wire may be configured in any number of ways, for example a (7×1) or (9×3). Also, stranded super elastic nickel titanium wire may be used, although the invention is not limited thereto.

The use of a stranded wire provides significant advantages in the flexibility of the antenna, while also providing the wear and corrosion resistance benefits of nickel and titanium, as well as the advantageous properties of Nitinol, such as shape memory effect, superelasticity, and high damping capability. The stranded nickel-titanium wire antenna element of the invention provides improved flexibility, while simultaneously reducing the risk of damage to the element.

In this illustrated embodiment, flexible element 101 may be mounted to a printed circuit board assembly 103 (such as when used for dual frequency applications) in any number of ways known to those of skill in the art, such as by soldering at solder point 109 as shown. Printed circuit board assembly 103 may comprise, for example, a circuit board containing integrated circuitry for transferring a signal received by flexible element 101 to signal cable 105.

A ferrule 102 may also be used for holding flexible element 101 in place; the operation of which is well known to those of ordinary skill in the art. Those of ordinary skill in the art will appreciate, however, that the use of the printed circuit board assembly 103 is not required, and whip element 101 may simply be attached to ferrule 102.

Signal cable 105 may be mounted within a mast stud insert 104, for example by using screw threads to secure the cable in place. In this embodiment, printed circuit board assembly 103 may be mounted to mast stud insert 104 by soldering, or other means, at solder point 110.

The composition of mast stud 104 is not particularly limited and may comprise any metal, such as aluminum, steel, or the like, or various rigid plastics. Once flexible element 101, circuit board assembly 103 and mast stud 104 are connected, a continuity test should be conducted to help ensure that proper contact has been made.

A mast support 106 may be mounted over mast stud 104 and circuit board assembly 103, as shown. Ferrule 102 may be mounted over flexible element 101 adjacent circuit board assembly 103, and may include threads for screwing and securing mast support 106 in place. Ferrule 102 may be mounted to flexible element 101 by a variety of means, such as crimping ferrule 102 in place. Flexible element 101 may be seated at the bottom of ferrule 102 prior to crimping. As with mast stud 104, mast support 106 and ferrule 102 may comprise any materials capable of operating in the manner shown, such as aluminum, steel, or rigid plastic (although not limited thereto).

Flexible element sleeve 108 maybe placed over flexible element 101. Flexible element sleeve 108 helps to protect radome 107 from RF (radio frequency) loading. The materials used for flexible element sleeve 108 are not particularly limited, and may comprise, for example, various plastics, rubbers, and the like. Any low loss dielectric material may be used. Mast radome 107 may be used to protect the entire assembly, and may be mounted snugly over the entire assembly, as shown in FIG. 1(b). The material used for mast radome 7 is also not particularly limited, and may comprise various plastics, rubbers, etc. In tightly fitting mast radome 107 over the assembly, a lubricant (e.g., a silicone based lubricant or the like) may be used within mast radome 107 in affixing it overtop the antenna assembly. Mast stud 104 should be fully seated within radome 107 to help ensure maximum protection of the antenna assembly.

Although this invention has been described with reference to particular embodiments, it will be appreciated that many variations may be resorted to without departing from the spirit and scope of this invention.

What is claimed is:

1. A flexible antenna element mountable on a base assembly, said element comprising a plurality of strands of a nickel-titanium alloy for transmitting signals from and receiving signals to said antenna.

2. The antenna element of claim 1, wherein said strands of nickel-titanium alloy are configured as one or more selected from the group consisting of 7×1 and 9×3.

3. The antenna element of claim 1, further comprising said base assembly.

4. The antenna element of claim 3, wherein said base assembly comprises a mast stud support for mounting said antenna element.

5. The antenna element of claim 3, further comprising a ferrule for mounting said antenna element to said base assembly.

6. The antenna element of claim 4, further comprising a mast stud insert for receiving a signal cable for communicating with said antenna element.

7. The antenna element of claim 3, wherein said base assembly further comprises a printed circuit board.

8. The antenna element of claim 1, further comprising a sleeve mounted over at least a portion of said antenna element.

9. The antenna element of claim 1, further comprising a radome mounted over at least a portion of said antenna element and said base assembly.

10. An antenna comprising:
a stranded nickel-titanium element for transmitting signals from and receiving signals to said antenna; and
a base assembly for mounting said stranded nickel titanium element to a surface.

11. The antenna of claim 10, wherein said strands of nickel-titanium alloy are configured as one or more selected from the group consisting of 7×1 and 9×3.

12. The antenna of claim 10, wherein said base assembly comprises a mast stud support for mounting said antenna element.

13. The antenna of claim 10, further comprising a ferrule for mounting said antenna element to said base assembly.

14. The antenna of claim 12, further comprising a mast stud insert for receiving a signal cable for communicating with said antenna element.

15. The antenna of claim 10, wherein said base assembly further comprises a printed circuit board.

16. The antenna element of claim 10, further comprising a sleeve mounted over at least a portion of said antenna element.

17. The antenna of claim 10, further comprising a radome mounted over at least a portion of said antenna element and said base assembly.

18. An antenna system comprising:
a stranded nickel-titanium element for transmitting signals from and receiving signals to said antenna system; and
a mast stud for receiving a signal cable for communication with said antenna element.

19. The antenna system of claim 18, wherein said stranded nickel-titanium element is one or more selected from the group consisting of 7×1 and 9×3.

20. The antenna system of claim 18, further comprising:
a sleeve mounted over at least a portion of said antenna element; and
a radome mounted over at least a portion of said antenna element and said mast stud.
